(19) United States
(12) Patent Application Publication
(10) Pub. No.: US 2022/0365456 A1
(43) Pub. Date: Nov. 17, 2022

(54) TONER PARTICLE WITH THERMALLY EXPANDABLE CAPSULE

(71) Applicant: HEWLETT-PACKARD DEVELOPMENT COMPANY, L.P., Spring, TX (US)

(72) Inventors: Takahiro DANNO, Yokohama, Kanagawa (JP); Keiichi ISHIKAWA, Yokohama, Kanagawa (JP); Osamu IEDA, Yokohama, Kanagawa (JP)

(21) Appl. No.: 17/765,554

(22) PCT Filed: Oct. 14, 2020
(86) PCT No.: PCT/US2020/055513

§ 371 Date: Mar. 31, 2022

(30) Foreign Application Priority Data
Oct. 25, 2019 (JP) 2019-194564

(51) Int. Cl. G03G 9/087; G03G 9/08; G03G 15/08

(52) U.S. Cl. CPC G03G 9/08755; G03G 9/08797; G03G 9/0821; G03G 15/0865

(57) ABSTRACT

A toner particle includes a binder resin, a thermally expandable capsule, a colorant, and a wax. The binder resin includes an amorphous polyester resin having a pendant group, and a crystalline polyester resin.

### BACKGROUND

Imaging techniques based on electrostatically charged images, such as electrophotography, are used in a variety of fields for rendering image information visible. In electrophotography, the surface of a photoreceptor is uniformly charged, and then formed with an electrostatically charged image, which is an electrostatic latent image that is developed with a developer including toner particles, such that the electrostatic latent image is rendered visible as a toner image. The toner image is transferred and fixed onto the surface of a recording medium, so as to form an image (e.g., a printed image). The developer may be a two-component developer composed of toner particles and a carrier, and/or a one-component developer that uses either a magnetic toner exclusively or a non-magnetic toner exclusively.

### DETAILED DESCRIPTION

Hereinafter, examples of a toner particle will be described. According to examples, the toner particle may contain a binder resin, thermally expandable capsule, a colorant, and a wax.

Binder Resin

According to examples, the binder resin includes a first amorphous polyester resin having a pendant group, a second amorphous polyester resin having no pendant group, and a crystalline polyester resin. According to examples, the amorphous polyester resin may be a polyester resin which does not have a clear endothermic peak in differential scanning calorimetry (DSC). The amorphous polyester resin may be defined as, for example, a polyester resin showing a stepwise endothermic change when measurement is made by differential scanning calorimetry at a rate of temperature increase of 10° C./min, or a polyester resin having an endothermic peak with a half-value width of more than 15° C.

According to examples, an amorphous polyester resin may be a reaction product of a polyhydric alcohol and a polycarboxylic acid. For example, the amorphous polyester resin may include, as monomer units, a polyhydric alcohol and a polycarboxylic acid. The example amorphous polyester resin includes an amorphous polyester resin having a pendant group (first amorphous polyester resin), and in some examples, the amorphous polyester resin includes an amorphous polyester resin having a pendant group (first amorphous polyester resin) and an amorphous polyester resin having no pendant group (second amorphous polyester resin).

The first amorphous polyester resin may contain, as monomer units: a polyhydric alcohol; a first polycarboxylic acid having a branch chain having 3 or more carbon atoms; and a second polycarboxylic acid that does not have a branch chain having 3 or more carbon atoms. The branch chain in the first polycarboxylic acid constitutes a pendant group for the first amorphous polyester resin.

The polyhydric alcohol may be, for example, a did. Examples of the diol include: aliphatic diols such as ethylene glycol, diethylene glycol, triethylene glycol, propylene glycol, butanediol, hexanediol, neopentyl glycol, and glycerin; alicyclic dials such as cyclohexanediol, cyclohexanedimethanol, and hydrogenated bisphenol A; and aromatic diols such as an ethylene oxide adduct of bisphenol A and a propylene oxide adduct of bisphenol A. Such polyhydric alcohols are used singly or in a combination of two or more kinds thereof. The diol may be an aromatic diol according to some examples, or an alicyclic diol according to other examples. In order to form a crosslinked structure or a branched structure to achieve a suitable or improved fixability, the polyhydric alcohol may further include, in addition to a diol, a polyhydric alcohol having a valency of 3 or higher (for example, glycerin, trimethylolpropane, or pentaerythritol).

According to examples, the content of the polyhydric alcohol may range from a minimum of 45% by mole, 47% by mole or 50% by mole, to a maximum of 55% by mole, 53% by mole or 51% by mole, based on the total amount of the monomer units in the first amorphous polyester resin.

The branch chain in the first polycarboxylic acid means, when a chain having two carboxyl groups in a polycarboxylic acid is employed as the main chain, a chain that is branched out from this main chain. The branch chain may be a chain-like hydrocarbon group and may be, for example, an alkyl group or an alkenyl group, According to examples, the number of carbon atoms of the branch chain may range from a minimum of 4, 6, 8, 10, 12, 14, 16 or 18, to a maximum of 32, 30, 28, 26, 24, 22, 20, 18, 16, 14 or 12.

The first polycarboxylic acid may be, for example, a dicarboxylic acid having a branch chain having 3 or more carbon atoms, and is to include an anhydride of a dicarboxylic acid having a branch chain having 3 or more carbon atoms. Examples of the first polycarboxylic acid include a succinic acid having an alkyl group having 3 or more carbon atoms, a succinic acid having an alkenyl group having 3 or more carbon atoms, an alkyl bis(succinic acid) having an alkyl group having 3 or more carbon atoms, an alkenyl bis(succinic acid) having an alkenyl group having 3 or more carbon atoms, and anhydrides thereof. Examples of the polycarboxylic acid include octyl succinic acid, decyl succinic acid, dodecyl succinic acid, tetradecyl succinic acid, hexadecyl succinic acid, octadecyl succinic acid, isooctadecyl succinic acid, hexenyl succinic acid, octenyl succinic acid, decenyl succinic acid, dodecenyl succinic acid, tetrapropenyl succinic acid, tetradecenyl succinic acid, hexadecenyl succinic acid, isooctadecenyl succinic acid, octadecenyl succinic acid, and nonenyl succinic acid. Such first polycarboxylic acids may be used singly or in a combination of two or more kinds thereof.

According to examples, in order to enhance or improve the dispersibility of the crystalline polyester resin in the first amorphous polyester resin, the content of the first polycarboxylic acid may range from a minimum of 1% by mole, 1.5% by mole or 2% by mole, to a maximum of 20% by mole, 18% by mole, 16% by mole, 14% by mole, 12% by mole, 10% by mole, 9% by mole or 8% by mole, based on the total amount of the monomer units in the first amorphous polyester resin.

The second polycarboxylic acid may be, for example, a dicarboxylic acid that does not have a branch chain having 3 or more carbon atoms, and is to include an anhydride of a dicarboxylic acid that does not have a branch chain having 3 or more carbon atoms. Examples of the second polycarboxylic acid include adipic acid, phthalic acid, isophthalic acid, terephthalic acid, tetrachlorophthalic acid, chlorophthalic acid, nitrophthalic acid, p-carboxyphenylacetic acid, p-phenylene-2-acetic acid, m-phenylene diglycolic acid, p-phenylene diglycolic acid, o-phenylene diglycolic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracene dicarboxylic acid, cyclohexane dicarboxylic acid, and anhydrides of these. Such second polycarboxylic acids may be used singly or in a combination of two or more kinds thereof.

The second polycarboxylic acid may also be a polycarboxylic acid having a valency of 3 or higher, which does not have a branch chain having 3 or more carbon atoms. Examples of this polycarboxylic acid include trimellitic acid, pyromellitic acid, naphthalene tricarboxylic acid, naphthalene tetracarboxylic acid, pyrene tricarboxylic acid, pyrene tetracarboxylic acid, and acid anhydrides, acid chlorides, or esters of such carboxylic acids.

The content of the second polycarboxylic acid may range from a minimum of 30% by mole, 32% by mole or 34% by mole, to a maximum of 52% by mole, 50% by mole or 48% by mole, based on the total amount of the monomer units in the first amorphous polyester resin.

According to examples, in order to enhance or improve the dispersibility of the crystalline polyester resin in the first amorphous polyester resin, the weight average molecular weight of the first amorphous polyester resin may range from a minimum of 5,000, 6,000 or 8,000, to a maximum of 40,000, 30,000, 25,000, 18,000 or 16,000.

The weight average molecular weight of the first amorphous polyester resin according to examples, may be measured according to gel permeation chromatography (GPC) of a tetrahydrofuran (THF)-soluble fraction. The weight average molecular weight may be determined by the following example method. Waters e2695 (manufactured by Nihon Waters K.K.) is used as a measuring apparatus, and two sets of Inertsil CN-3 25 cm (manufactured by GL Sciences, Inc.) are used as columns. A filtrate obtained by introducing 10 mg of a first amorphous polyester resin into 10 mL of tetrahydrofuran (THF) (containing a stabilizer, manufactured by Wako Pure Chemical Industries, Ltd.), stirring the mixture for one hour, and then filtering the mixture through a 0.2 μm filter, is used as a sample. A sample solution in tetrahydrofuran (THF) is injected into the measuring apparatus in an amount of 20 μL, and measurement is made under the conditions of 40° C. and a flow rate of 1.0 mL/min.

According to examples, the glass transition temperature (Tg) of the first amorphous polyester resin may range from a minimum of 50° C., to a maximum of 80° C. or of 70° C.

According to examples, the content of the first amorphous polyester resin may range from a minimum of 55% by mass, 70% by mass or 80% by mass, to a maximum of 92% by mass, 90% by mass, 85% by mass or 80% by mass, based on the total amount of the binder resin. The content of the first amorphous polyester resin may range from a minimum of 48% by mass or 56% by mass, to a maximum of 72% by mass or 64% by mass, based on the total amount of the toner particle.

The second amorphous polyester resin contains a polyhydric alcohol and a polycarboxylic acid that does not have a branch chain having 3 or more carbon atoms as monomer units. Examples of the polyhydric alcohol and the polycarboxylic acid that does not have a branch chain having 3 or more carbon atoms are similar to the polyhydric alcohols and the polycarboxylic acid that does not have a branch chain having 3 or more carbon atoms (second polycarboxylic acid) described for the first amorphous polyester resin, respectively. The second amorphous polyester resin may include one kind or two kinds of the polyhydric alcohol and one or two kinds of the polycarboxylic acid that does not have a branch chain having 3 or more carbon atoms.

The content of the polyhydric alcohol may range from a minimum of 45% by mole, 47% by mole or 50% by mole, to a maximum of 55% by mole, 53% by mole, or 51% by mole, based on the total amount of the monomer units in the second amorphous polyester resin.

The content of the polycarboxylic acid that does not have a branch chain having 3 or more carbon atoms may range from a minimum of 45% by mole, 47% by mole or 49% by mole, to a maximum of 55% by mole, 53% by mole or 50% by mole, based on the total amount of the monomer units in the second amorphous polyester resin.

In order to suppress or inhibit a decrease in the strength of the binder resin and a decrease in the glass transition temperature of the toner particle, and to enhance or improve low-temperature fixability, the intensity of images fixed on paper, and the preservability of the toner particle, the weight average molecular weight of the second amorphous polyester resin may range from a minimum of 30,000, 40,000 or 50,000, to a maximum of 80,000, 70,000 or 60,000. The weight average molecular weight of the second amorphous polyester resin may be measured by a similar method as that for the weight average molecular weight of the first amorphous polyester resin.

According to examples, the content of the second amorphous polyester resin may range from a minimum of 24% by mass, 30% by mass or 34% by mass, to a maximum of 40% by mass, 38% by mass, 36% by mass or 34% by mass, based on the total amount of the binder resin. The content of the second amorphous polyester resin may range from a minimum of 20% by mass or 24% by mass, to a maximum of 31% by mass or 27% by mass, based on the total amount of the toner particle.

The crystalline polyester resin may be a polyester resin having a clear endothermic peak in modified differential scanning calorimetry (MDSC). The binder resin may include a crystalline polyester resin, in order to enhance or improve the image glossiness of the toner and to enhance or improve the low-temperature fixability.

A crystalline polyester resin is, for example, a reaction product between a polyhydric alcohol and a polycarboxylic acid. Accordingly, the crystalline polyester resin may include a polyhydric alcohol and a polycarboxylic acid as monomer units.

According to examples, the polyhydric alcohol may be a diol. In order to more easily form a crystalline polyester having a suitable or targeted melting point for the toner particle, according to examples, the number of carbon atoms of the polyhydric alcohol may range from a minimum of 8 or 9, to a maximum of 12 or 10. In some examples, the number of carbon atoms of the polyhydric alcohol may be of 9 or 10. Examples of the polyhydric alcohol include 1,9-nonanediol.

The polycarboxylic acid may be, for example, an aliphatic polycarboxylic acid, and may be a dicarboxylic acid. In order to increase a linearity of the structure of the crystalline polyester resin, and to enhance or improve the affinity with the first amorphous polyester resin, the polycarboxylic acid may be an aliphatic dicarboxylic acid. In order to more easily form a crystalline polyester having a suitable or targeted melting point for the toner particle, the number of carbon atoms of the polycarboxylic acid (excluding the carbons constituting a carboxyl group) may range from a minimum of 8 or 9, to a maximum of 12 or 10. According to examples, the number of carbon atoms may be of 9 or 10. Examples of the polycarboxylic acid include 1,10-decane dicarboxylic acid and 1,12-dodecane dicarboxylic acid.

In order to suppress or inhibit a decrease in the strength of the binder resin and a decrease in the glass transition temperature of the toner particle, and to enhance or improve the low-temperature fixability, the intensity of images fixed on paper, and the preservability of the toner particle, the weight average molecular weight of the crystalline polyester resin may range from a minimum of 5,000, 5,100 or 5,400, to a maximum of 15,000, 10,000, 8,000, 5,900 or 5,700. The weight average molecular weight of the crystalline polyester resin may be measured by a similar method as that for the weight average molecular weight of the first amorphous polyester resin.

In order to suppress or inhibit an aggregation of the toner particles, and to enhance or improve the preservability of fixed images and the low-temperature fixability, the melting temperature (Tm) of the crystalline polyester may range from a minimum of 55° C. to a maximum of 100° C. or 75° C.

According to examples, the crystalline polyester resin may have an endothermic energy amount Tg2nd-dH in a differential scanning calorimetric curve measured using a modified differential scanning calorimeter (MDSC). In order to suppress or inhibit a decrease in the strength of the binder resin and a decrease in the glass transition temperature of the toner particle, and to enhance or improve the low-temperature fixability, the intensity of images fixed on paper, and the preservability of the toner particle, the Tg2nd-dH of the crystalline polyester resin may be of 25 J/g or more, or of 40 J/g or more, according to examples.

The Tg2nd-dH of a crystalline polyester resin refers to the amount of endothermic energy of the polyester resin measured at the second time using a modified differential scanning calorimeter (MDSC). The Tg2nd-dH can be determined by the following example method. For a crystalline polyester resin, temperature increase is carried out as a first temperature increase process, using a modified differential scanning calorimeter Q2000 (manufactured by TA Instruments, Inc.), from room temperature to 140° C. at a modulation amplitude of 0.1° C., a modulation cycle of 10 seconds, and a rate of 3° C. per minute, and after completion, the temperature is decreased to 0° C. at a rate of 20° C. per minute. The temperature is held at 0° C. for 5 minutes, and then temperature increase is carried out again as a second temperature increase process from 0° C. to 140° C. at a modulation amplitude of 0.1° C., a modulation cycle of 10 seconds, and a rate of 3° C. per minute. Thus, dH is determined from a differential scanning calorimetric curve thus obtained.

According to examples, the content of the crystalline polyester resin may range from a minimum of 8% by mass, 10% by mass or 12% by mass, to a maximum of 30% by mass or 20% by mass, based on the total amount of the binder resin. The content of the crystalline polyester resin may range from a minimum of 6% by mass or 8% by mass, to a maximum of 20% by mass or 10% by mass, based on the total amount of the toner particle.

The mass ratio of the content of the amorphous polyester resins to the content of the crystalline polyester resins (content (mass) of amorphous polyester resins/content (mass) of crystalline polyester resins) may range from a minimum of 80/20 or 85/15, to a maximum of 95/5 or 90/10.

The binder resin may further include other resins in addition to the amorphous polyester resin and crystalline polyester resin. Examples of the other resins include a styrene-(meth)acrylic copolymer, an epoxy resin, and a styrene-butadiene copolymer. The styrene-(meth)acrylic copolymer may be a copolymer of a styrene-based monomer and a (meth)acrylic acid ester-based monomer. Examples of the styrene-based monomer include styrene, o-(m-, p-) methylstyrene and m-(p-) ethylstyrene. Examples of the (meth)acrylic acid ester-based monomer include methyl (meth)acrylate, ethyl (meth)acrylate, propyl (meth)acrylate, butyl (meth)acrylate, octyl (meth)acrylate, dodecyl (meth)acrylate, stearyl (meth)acrylate, behenyl (meth)acrylate, 2-ethylhexyl (meth)acrylate, dimethylaminoethyl (meth)acrylate, and diethylaminoethyl (meth)acrylate.

According to examples, the total content of the amorphous polyester resin and crystalline polyester resin in the binder resin may range from a minimum of 80% by mass, 85% by mass or 90% by mass, to a maximum of 98% by mass, or 95% by mass, based on the total amount of the binder resin.

The Tg2nd-dH of the binder resin may range from a minimum of 5 J/g, 10 J/g, 14 J/g or 15 J/g, to a maximum of 50 J/g, 40 J/g, 25 J/g, 19 J/g or 18 J/g. The Tg2nd-dH of the binder resin may refer to, for example, an index representing the compatibility between the first amorphous polyester resin and the crystalline polyester resin. The Tg2nd-dH of the binder resin may be measured by a similar method as that for the Tg2nd-dH of the crystalline polyester resin.

The content of the binder resin in the toner particle may range from a minimum of 40% by mass, 45% by mass or 50% by mass, to a maximum of 90% by mass, 85% by mass or 75% by mass, based on the total amount of the toner particle.

Thermally Expandable Capsule

A thermally expandable capsule may include, for example, a hollow shell (wall material) and a thermally expandable component enclosed in the shell. The shell may be formed from a polymer. This polymer may be, for example, an acrylonitrile-based polymer, a (meth)acrylic polymer, a styrene-based polymer, a silicone resin, a urethane resin, an amide resin, and/or the like. In some examples, the polymer is an acrylonitrile-based polymer. The acrylonitrile-based polymer is a polymer including acrylonitrile as a monomer unit, and in order to increase adhesiveness to the binder resin and increase solvent-resistance, the acrylonitrile-based polymer may be a copolymer of acrylonitrile and vinylidene chloride.

A thermally expandable component may be a component that expands by absorbing heat and undergoing phase change from a liquid phase to a gas phase. The thermally expandable component may be, for example, a hydrocarbon, and may be a hydrocarbon having a boiling point of 50° C. or lower (boiling point at atmospheric pressure). The boiling point (boiling point at atmospheric pressure) of the hydrocarbon may range between a maximum of 40° C., 30° C., 20° C. or 10° C., and a minimum of −30° C., −20° C. or −15° C. Such a hydrocarbon may be, for example, neopentane, neohexane, isopentane, isobutylene, isobutane, and/or the like, in order to impart stability with respect to the shell and to improve the coefficient of thermal expansion, the hydrocarbon may be isobutane.

The average particle size of the thermally expandable capsules may range from a minimum of 5 μm, 10 μm or 15 μm, to a maximum of 70 μm, 60 μm or 50 μm. The average particle size of the thermally expandable capsules is measured as the value of D50 in a particle size distribution obtained by a particle size distribution measuring method (laser diffraction scattering method).

In order to achieve a suitable or improved low-temperature fixability, the thermally expandable capsule may have an expansion initiation temperature that is greater than a temperature T1 at which the storage modulus of the toner particles is 1×10⁵ Pa. According to examples, the expansion initiation temperature of the thermally expandable capsule may be higher than the temperature T1 by a temperature range, for example, of 3° C. to 43° C., of 3° C. to 13° C., of 10° C. to 20° C., of 13° C. to 33° C., or of 33° C. to 43° C.

In order to suppress or inhibit a phenomenon in which the toner particles melt excessively and migrate to a heating member (hot offset), the thermally expandable capsule may have an expansion initiation temperature lower than a temperature T2 at which the storage modulus of the toner particles is 5×10³ Pa. According to examples, the expansion initiation temperature of the thermally expandable capsule may be lower than the temperature T2 by a temperature range, for example, of 5° C. to 50° C. of 5° C. to 20° C., of 10° C. to 20° C., of 20° C. to 35° C., or of 35° C. to 50° C.

The expansion initiation temperature of the thermally expandable capsule may be measured by preparing a sample in which an aluminum cup containing thermally expandable capsule is covered with an aluminum lid, measuring the height of an indenter applying a constant force (300 Pa) on the sample using a dynamic viscoelasticity apparatus, and heating the sample at a constant rate of temperature increase (10° C./min), the expansion initiation temperature being measured as a displacement initiation temperature in a direction perpendicular to the indenter.

The temperature T1 at which the storage modulus of the toner particles is 1×10⁵ Pa, and the temperature T2 at which the storage modulus of the toner particles is 5×10³ Pa may be measured by the following example method. As a measuring apparatus, a rotating flat plate type rheometer “ARES” (manufactured by TA Instruments, Inc.) is used. As a measurement sample, a sample obtained by pressure molding 0.25 g at 20 MPa for 1 minute using a tablet molding machine is used. The storage modulus G′ at the time of increasing the temperature from 40° C. to 180° C. under the conditions of a rate of temperature increase of 2° C./min, a frequency of 10 Hz, and a strain control mode (strain amount 0.01% to 3%) is measured at an increment of 1° C., and the first temperature at which the storage modulus G′ is below 1×10⁵ Pa is designated as T1, while the first temperature at which the storage modulus G′ is below 5×10³ Pa is designated as T2.

In order to achieve a suitable or improved low-temperature fixability and to suppress or inhibit hot offset, the content of the thermally expandable capsule in the toner particles may be within a range that has a minimum of 0.5% by mass, 1% by mass or 1.5% by mass, based on the total amount of the toner particles to obtain a suitable fixability, and that has a maximum of 5% by mass, 4.5% by mass or 4% by mass, based on the total amount of the toner particles.

Colorant

The colorant can include at least one colorant selected from, for example, a black colorant, a cyan colorant, a magenta colorant, and a yellow colorant. Regarding the colorant, one kind is used alone, or two or more kinds are used as a mixture, in consideration of hue, chroma, brightness, weather-resistance, dispersibility in toner, and/or the like.

The black colorant may be carbon black or aniline black. The yellow colorant may be a condensed nitrogen compound, an isoindolinone compound, an anthraquine compound, an azo metal complex, or an allylimide compound. Examples of the yellow colorant include C.I. Pigment Yellow 12, 13, 14, 17, 62, 74, 83, 93, 94, 95, 109, 110, 111, 128, 129, 147, 168, and 180.

The magenta colorant may be a condensed nitrogen compound, anthraquine, a quinacridone compound, a basic dye lake compound, a naphthol compound, a benzimidazole compound, a thioindigo compound, or a perylene compound. Examples of the magenta colorant include C.I. Pigment Red 2, 3, 5, 6, 7, 23, 48:2, 48:3, 48:4, 57:1, 81:1, 122, 144, 146, 166, 169, 177, 184, 185, 202, 206, 220, 221, and 254.

The cyan colorant may be a copper phthalocyanine compound or a derivative thereof, an anthraquine compound, and/or the like. Examples of the cyan colorant include C.I. Pigment Blue 1, 7, 15, 15:1, 15:2, 15:3, 15:4, 60, 62, and 66.

According to examples, the content of the colorant may be within a range that has a minimum of 0.5% by mass, 1% by mass or 2% by mass, based on the total amount of the toner particle, in order to exhibit a sufficient or improved coloration effect, and that has a maximum of 15% by mass, 12% by mass or 10% by mass, based on the total amount of the toner particle, in order to achieve a sufficient amount of frictional electrification without having significant influence on the increase in the production cost of the toner particle.

Wax

A wax can function as, for example, a mold release agent. A mold release agent may enhance low-temperature fixability, final image durability; and abrasion resistance characteristics of the toner particle. Accordingly, the type and content of the wax that serves as a mold release agent can be determined by taking into consideration the characteristics of the toner.

The wax may be a natural wax or a synthetic wax. According to some examples, the type of the wax can be selected from the group consisting of, for example, a polyethylene-based wax, a polypropylene-based wax, a silicon wax, a paraffin-based wax, an ester-based wax, a carnauba wax, beeswax, a metallocene wax, and/or the like, Some examples of wax include solid paraffin wax, microwax, rice wax, a fatty acid amide-based wax, a fatty acid-based wax, an aliphatic monoketone, a fatty acid metal salt-based wax, a fatty acid ester-based wax, a partially saponified fatty acid ester-based wax, a silicone varnish, a higher alcohol, and carnauba wax. Furthermore, a polyolefin such as a low-molecular weight polyethylene or polypropylene, and/or the like can also be used.

The wax may be an ester-based wax containing an ester group. Examples thereof include a mixture of an ester-based wax and a non-ester-based wax, and an ester group-containing wax obtained by incorporating an ester group into a non-ester-based wax.

With regard to an ester-based wax component, an ester group has a relatively high affinity with a latex component of toner particle, and accordingly the wax can be made to be uniform within the toner particle, in order to improve the effect of the action of the wax. A non-ester-based wax component tends to suppress the excessive plasticizing action when the wax is composed of ester-based waxes exclusively, as a result of mold release action with latex. Accordingly, a mixture of an ester-based wax and a non-ester-based wax may be used to maintain sufficient or suitable developability of toner for a substantially long period of time.

The ester-based wax may be an ester of a fatty acid having 15 to 30 carbon atoms and a monohydric alcohol to a pentahydric alcohol, such as behenyl behenate, stearyl stearate, stearic acid ester of pentaerythritol, and montanic acid glyceride. The alcohol component constituting the ester may be a monohydric alcohol having 10 to 30 carbon atoms or a polyhydric alcohol having 3 to 30 carbon atoms. Examples of the non-ester-based wax include a polyethylene-based wax, a polypropylene-based wax, a silicon wax, and a paraffin-based wax.

Examples of the ester-based wax containing an ester group include a mixture of a paraffin-based wax and an ester-based wax, and an ester group-containing paraffin-based wax, and some examples thereof include, for example, product names P-212, P-280, P-318, P-319, and P-419 of CHUKYO YUSHI CO., LTD.

In examples where the wax is a mixture of a paraffin-based wax and an ester-based wax, the content of the ester-based wax may be within a range that has a minimum of 1% by mass, 5% by mass, 10% by mass or 15% by mass, based on the total amount of the mixture of a paraffin-based wax and an ester-based wax, in order to sufficiently or suitably maintain the compatibility with a latex that is used at the time of production of toner particles, and that has a maximum of 50% by mass based on the total amount of the toner particle in order to achieve a suitable plasticity of the toner particle and to achieve long-term maintenance of developability.

The melting temperature of the wax may range from a minimum of 60° C. or 70° C., to a maximum of 100° C. or 90° C. The wax component may be a component that physically adheres tightly to toner particle but does not form covalent bonding with the toner particle.

In order to suppress or inhibit a plasticization phenomenon between the binder resin and the wax, the wax may have a solubility parameter (SP) value, such that a difference between the SP value of the wax and the solubility parameter (SP) value of the binder resin is 2 or more.

The content of the wax may be within a range that has a minimum of 1% by mass, 2% by mass, or 3% by mass, based on the total amount of the toner particle, in order to achieve a sufficient or suitable low-temperature fixability and a sufficient fixing temperature range, and that has a maximum of 20% by mass, 16% by mass, or 12% by mass, based on the total amount of the toner particle, in order to improve preservability and economic efficiency,

Other Components

According to examples, the toner particle may additionally include a charge control agent. The charge control agent may be internally added or externally added to the toner particle. The charge control agent may be a negative charge control agent or a positive charge control agent.

Examples of the negative charge control agent include a salicylic acid metal compound, a naphthoic acid metal compound, a dicarboxylic acid metal compound, a polymer type compound having sulfonic acid or carboxylic acid in a side chain, a polymer type compound having a sulfonic acid salt or a sulfonic acid esterification product in a side chain, a polymer type compound having a carboxylic acid salt or a carboxylic acid esterification product in a side chain, a boron compound, a urea compound, a silicon compound, and a calixarene.

Examples of the positive charge control agent include a quaternary amount salt, a polymer type compound having a quaternary ammonium salt in a side chain, a guanidine compound, and an imidazole compound.

The toner particle may further include inorganic microparticles in some examples. The inorganic microparticles may be internally added or externally added to the toner particles. Examples of the inorganic microparticles include silica microparticles, titanium oxide microparticles, and aluminum oxide microparticles. Such inorganic microparticles may be, for example, hydrophobized with a hydrophobizing agent such as a silane compound, a silicone oil, or a mixture thereof.

According to examples, the specific surface area of the inorganic microparticles may range from a minimum of 10 m²/g or of 50 m²/g to a maximum of 400 m²/g or of 50 m²/g. In some examples, the content of the inorganic microparticles may range from a minimum of 0.1% by mass to a maximum of 10% by mass, based on the total amount of the toner particle.

The toner particle may contain iron element, silicon element, and sulfur element, and in addition to these elements, fluorine element may be further incorporated in some examples. According to examples, the iron element and silicon element may be components that originate from an aggregating agent and/or the like. Sulfur element may be a component originating from a production catalyst for a self-adhesive resin, an aggregating agent, and/or the like. Fluorine element may be a component originating from a production catalyst for a self-adhesive resin and/or the like.

In order to improve the toner particle so as to be more suitable for use in developing an electrostatically charged image, the content of iron element may range from a minimum of 1.0×10³ ppm to a maximum of 1.0×10⁴ ppm or of 5.0×10³ ppm. In order to further improve the toner particle to be more suitable for use in developing an electrostatically charged image, the content of silicon element may range from a minimum of 1.0×10³ ppm or 1.5×10³ ppm, to a maximum of 5.0×10³ ppm or 4.0×10³ ppm. The contents of iron element and silicon element can be controlled by regulating the type, amount, and/or the like of the aggregating agent to be used.

In order to improve the toner particle to be more suitable for use in developing an electrostatically charged image, the content of sulfur element may range from a minimum of 500 ppm or 1,000 ppm, to a maximum of 3,000 ppm. The content of sulfur element can be controlled by regulating the types, amounts, and/or the like of the catalyst and aggregating agent to be used.

In order to improve the toner particle so as to be more suitable for use in developing an electrostatically charged image, the content of fluorine atom may range from a minimum of 1.0×10³ ppm or 5.0×10³ ppm, to a maximum of 1.0,<10⁴ ppm or 8.0,<10³ ppm. The content of fluorine atom can be controlled by regulating the type and amount of the catalyst to be used.

The contents of the various elements in the toner particle can be measured by, for example, fluorescent X-ray analysis. For example, an X-ray analyzer EDX-720 (manufactured by SHIMADZU CORPORATION) may be used as a measuring apparatus, and measurement can be performed under the conditions of an X-ray tube voltage of 50 kV and an amount of sample molding of 30.0 g. The contents of various elements can be determined by utilizing the intensity (cps/μA) from the quantification results derived by fluorescent X-ray analysis.

According to examples, the average particle size of the toner particles may range from a minimum of 4 μm or 5 to a maximum of 7 μm or 6 μm. The average particle size of the toner particles is a volume average particle size that may be determined by the following example method.

The volume average particle size of the toner particles may be measured by a pore electrical resistance method. According to the method, a Coulter counter (manufactured by Beckman Coulter, Inc.) is used as a measuring apparatus, ISOTON II (manufactured by Beckman Coulter, Inc.) is used as an electrolytic solution, an aperture tube having an aperture diameter of 100 μm is used, and measurement is performed under the conditions of a number of particles measured of 30,000. Based on a particle size distribution of the particles thus measured, the volumes occupied by the particles included in divided particle size ranges are cumulated from the smaller diameter side, and the cumulative 50% particle size is designated as the volume average particle size Dv50.

According to examples of the toner particle that are described above, the pendant groups in the amorphous polyester resin may work as crystallization nuclei for crystalline components, to finely disperse the crystalline polyester resin that tends to aggregate. In addition, the toner particle may include the thermally expandable capsule, in order to suppress a supply of excess heat energy to the binder resin and to suppress a decrease in the elasticity of the binder resin when excess heat energy is supplied, since heat energy can be absorbed by the thermally expandable capsule and converted to the heat of vaporization.

According to examples, the toner particle can be used as a one-component developer (or single-component developer). In order to further enhance dot reproducibility and to supply stable images over a long period of time, the toner particle can be mixed with a magnetic carrier and used as a two-component developer (or dual-component developer).

Examples of the magnetic carrier include: iron oxide; metal particle such as iron, lithium, calcium, magnesium, nickel, copper, zinc, cobalt, manganese, chrome, and rare earth elements; particle of alloys thereof, particle of oxides thereof; magnetic bodies such as ferrites; and a magnetic body-dispersed resin carrier (also referred to as resin carrier) containing a magnetic body and a binder resin that maintains the magnetic body in a dispersed state.

In examples where the toner particles are mixed with a magnetic carrier and are used as a two-component developer, the content of the toner particle may range from a minimum of 2% by mass or 4% by mass, to a maximum of 15% by mass or 13% by mass, based on the total amount of the two-component developer.

The toner particle may be accommodated in, for example, a toner cartridge. For example, the toner particle may be accommodated within a container in a toner cartridge. In other examples, a toner cartridge may include a container that accommodates the toner particle described above.

### EXAMPLES

Some examples of the toner particle will be described hereinafter, although the toner particle is not limited to such examples.

Preparation of first amorphous polyester resins 1A and 1B, and comparative amorphous polyester resin 1a

Polyhydric alcohols, polycarboxylic acids, and esterification catalysts in the feed amounts shown in Table 1 were introduced into a 5-liter four-necked flask equipped with a nitrogen inlet tube, a dewatering tube, a stirrer, and a thermocouple, and the components were caused to react at 230° C. in a nitrogen atmosphere. The resulting first amorphous polyester resins 1A and 1B, and comparative amorphous polyester resin 1a, have the physical properties indicated in Table 1.

TABLE 1

| | | | | | Comparative |
|---|---|---|---|---|---|
| | | | First amorphous | | amorphous |
| | | | polyester resin | | polyester resin |
| | | | 1A | 1B | 1a |
| Feed | Polyhydric | Propylene oxide | 52 | 51 | 51 |
| amount | alcohol | adduct of | | | |
| (% by | | bisphenol A | | | |
| mole) | | (average number | | | |
| | | of added moles 2) | | | |
| | First | Dodecenyl succinic | 13 | 6 | — |
| | polycarboxylic | acid | | | |
| | acid | | | | |
| | Second | Terephthalic acid | 34 | 42 | 49 |
| | polycarboxylic | | | | |
| | acid | | | | |

| | | | |
|---|---|---|---|
| Weight average molecular weight | 8087 | 10658 | 10685 |

300 g of a first amorphous polyester resin or a comparative amorphous polyester resin, 250 g of methyl ethyl ketone, and 50 g of isopropyl alcohol were introduced into a 3-liter double-jacketed reactor. The interior of the reaction vessel was stirred using a semi-moon type impeller in an environment having a temperature of approximately 30° C. to dissolve the resin so as to obtain a resin solution. While the resin solution was stirred, 20 g of a 5% aqueous solution of ammonia was slowly added into the reaction vessel, and subsequently 1,200 g of water was added at a rate of 20 g/min to produce an emulsion. Subsequently, a mixed solvent of methyl ethyl ketone and isopropyl alcohol was removed from the emulsion by a reduced pressure distillation method until the concentration of the amorphous polyester resin as a solid component became 20% by mass. As a result, a latex of the first amorphous polyester resin or the comparative amorphous polyester resin was obtained.

Preparation of Second Amorphous Polyester Resin

A second amorphous polyester resin was synthesized in a similar manner as in the case of the first amorphous polyester resins 1A and 1B, with the exception that 50% by mole of a propylene oxide adduct of bisphenol A (average number of added moles 2), 40% by mole of isophthalic acid, 8% by mole of adipic acid, and 2% by mole of trimellitic anhydride were used as monomers. As a result, a latex of the amorphous polyester resin was obtained. The weight average molecular weight of this second amorphous polyester resin was 56,204.

Preparation of Crystalline Polyester Resin

133 g of 1,9-nonanediol (manufactured by Wako Pure Chemical Industries, Ltd.), 167 g of 1,12-dodecane dicarboxylic acid (manufactured by Wako Pure Chemical Industries, Ltd.), and an esterification catalyst were introduced into a 500-milliliter separable flask. Subsequently, nitrogen was introduced into the flask, and while the interior of the flask was stirred with a stirring apparatus, a mixture of 1,9-nonanediol and the esterification catalyst was heated to 80° C. and melted. Subsequently, while the interior of the flask was stirred, the temperature of the mixed solution inside the flask was increased to 97° C. Subsequently, a vacuum (10 mPa·s or less) was drawn inside the flask, and while the interior of the flask was stirred, a dehydration condensation reaction between 1,9-nonanediol and 1,12-dodecane dicarboxylic acid was carried out for 5 hours at 97° C. As a result, a crystalline polyester resin was obtained. The weight average molecular weight of this crystalline polyester resin was 5,600, and Tg2nd-dH was 149 J/g.

A crystalline polyester resin latex was obtained by a similar procedure as that for the amorphous polyester resin latex, with the exception that the crystalline polyester resin was used instead of an amorphous polyester resin.

Preparation of Colorant Dispersion Liquid

10 g of an anionic reactive emulsifier (HS-10: manufactured by DKS Co. Ltd.) was introduced into a milling bath together with 60 g of a Cyan pigment (C.I. Pigment Blue 15:3: manufactured by Clariant AG), into which 400 g of glass beads having a diameter of 0.8 to 1 mm were introduced, and milling was performed at normal temperature. As a result, a colorant dispersion liquid was obtained.

### Example 1

Preparation of Toner Particles

500 g of deionized water, 472 g of the latex of the first amorphous polyester resin 1A, 202 g of the latex of the second amorphous polyester resin, and 169 g of the latex of the crystalline polyester resin were added into a 3L reactor, and 60 g of the colorant dispersion liquid, 80 g of a wax dispersion liquid (SELOSOL P-212: manufactured by CHUKYO YUSHI CO., LTD.), and 70 g of polysilicato-iron (PSI-100, manufactured by SUIDO KIKO KAISHA, LTD.) as an aggregating agent were added. While these were stirred using a homogenizer (ULTRA-TURRAX TSO™ (trade name) manufactured by IKA-Werke GmbH & CO. KG), the temperature of the mixed solution in the flask was increased to 45° C. at a rate of 1° C./min. Subsequently, the temperature of the aggregate reaction liquid was increased at a rate of 0.2° C./min to continue an aggregation reaction, to obtain primary aggregated particles (cores) having a volume average particle size of 4 to 6 μm. In addition, 147 g of a latex of the first amorphous polyester resin 1A and 63 g of a latex of the second amorphous polyester resin were added to the reactor, and the mixture was caused to aggregate for 30 minutes, so as to form a shell to cover the primary aggregated particles.

A 0.1 N aqueous solution of NaOH was added, and the pH of the mixed liquid was adjusted to 9.5. After a lapse of 20 minutes, the temperature of the mixed liquid was increased, the mixed liquid was subjected to fusing for 3 hours or longer and 5 hours or shorter, to obtain secondary aggregated particles having a volume average particle size of 4 to 7 μm. Into this aggregated reaction liquid, ice of deionized water was introduced at a rate of introduction of 100 ml/10 sec, the aggregated reaction liquid was cooled to 28° C. or lower, subsequently particles were separated through a filtration process and dried. As a result, a toner particle precursor was obtained.

To 100 parts by mass of the toner particle precursor obtained as described above, 1.3 parts by mass of small particle-sized silica R8200 (average particle size 12 nm, manufactured by NIPPON AEROSIL CO., LTD.), 1.7 parts by mass of medium particle-sized silica RX50 (volume average particle size 40 nm, manufactured by NIPPON AEROSIL CO., LTD.), 1.0 part by mass of large particle-sized silica (X24-9600A-80, volume average particle size 80 nm, manufactured by Shin-Etsu Chemical Co., Ltd.), 0.5 part by mass of titanium oxide (volume average particle size 15 nm, JMT150IB, manufactured by Tayca Corporation), and 3.0 parts by mass of thermally expandable capsule A (EML-101; manufactured by SEKISUI CHEMICAL CO., LTD., particle size: 12 to 18 μm, expansion initiation temperature: 115° C.) were added, and the mixture was mixed for 3 minutes at 6,000 rpm using a Powder mixer (Model No. KM-LS-2K, manufactured by KM TECH Co., Ltd.). As a result; toner particles were obtained.

### Example 2

Toner particles were obtained in a similar manner as in Example 1, with the exception that the first amorphous polyester resin 1B was used instead of the first amorphous polyester resin 1A.

### Example 3

Toner particles were obtained in a similar manner as in Example 1, with the exception that the content of the crystalline polyester resin in the binder resin was changed to 25% by mass.

### Example 4

Toner particles were obtained in a similar manner as in Example 3, with the exception that thermally expandable capsule B (F-35D, manufactured by Matsumoto Yushi-Seiyaku Co., Ltd., particle size: 10 to 20 μm, expansion initiation temperature: 80° C.) were used instead of the thermally expandable capsule A.

### Example 5

Toner particles were obtained in a similar manner as in Example 1, with the exception that the amount of addition of the thermally expandable capsule A was changed to 1.0 part by mass.

### Example 6

Toner particles were obtained in a similar manner as in Example 1, except that the amount of addition of the thermally expandable capsule A was changed to 5.0 parts by mass.

### Comparative Example 1

Toner particles were obtained in a similar manner as in Example 1, with the exception that the thermally expandable capsule A was not used.

### Comparative Example 2

Toner particles were obtained in a similar manner as in Example 1, with the exception that the comparative amorphous polyester resin 1a was used instead of the first amorphous polyester resin 1A.

### Comparative Example 3

Toner particles were obtained in a similar manner as in Example 1, with the exception that the toner particles were obtained without using any crystalline polyester resin.

For the toner particles obtained as described above, the respective results of measurements of the temperature T1 (° C.) at which the storage modulus was 1×10⁵ Pa and of the temperature T2 (° C.) at which the storage modulus was 5×10³ Pa are indicated in Tables 2A and 2B. In Tables 2A and 2B, a difference T0−T1 (° C.) between the expansion initiation temperature T0 (° C.) of the thermally expandable capsule and the temperature T1 (° C.), and a difference T2−T0 (° C.) between the temperature T2 (° C.) and the expansion initiation temperature T0 (° C.) of the thermally expandable capsule are also shown.

The following evaluations were performed for each of the obtained toner particles. The results are shown in Tables 2A and 2B.

Evaluation of Low-Temperature Fixability

An OHP sheet from which a square having a size of 25 mm×40 mm had been hollowed out was arranged to face a masked 90 g/m² paper, and toner particles were scraped off from above a SUS316 ϕ0.04×300 mesh (sieve opening 0.04 mm) at an applied voltage of 1 kV such that the weight of the toner on the paper would be 0.36 mg/cm².

An external fixing device obtained by modifying a fixing device of MultiXpress 7 (manufactured by Samsung Electronics Co., Ltd.) was used, and under the conditions of a heat belt linear velocity of 280 mm/sec, the heat belt surface temperature and the surface temperature of a pressure roller were monitored using a radiation thermometer (ε: 0.98). When the surface temperature of the pressure roller reached −20° C. with respect to the heat belt temperature, paper having an unfixed image printed thereon was fed.

The image density of the image on the fed paper was measured using a colorimeter (X-rite eXact, manufactured by X-Rite, Incorporated). SCOTCH™ (registered trademark) tape was attached to the image, a sheet of paper having a basis weight of 60 g/m³ was interposed between the tape and a weight of 500 g which was reciprocated (e.g., moved back-and-forth) five times over the sheet of paper, after which the tape was peeled off at 180°. The image density was measured after peeling off the tape, and the image density after peeling with respect to the image density before peeling was designated as the fixing strength. The above-described operation was carried out by varying the heat belt temperature, and the temperature at which the fixing strength reached 90% was designated as the lowest fixing temperature. The low-temperature fixability may be considered suitable or sufficiently improved when the lowest fixing temperature is 135° C. or lower.

Evaluation of Fixable Temperature Range

Paper having an unfixed image printed thereon was fed while increasing the heat belt surface temperature by increments of 5° C. in a similar manner as in the evaluation of low-temperature fixability, with the exception that the 90 g/m² paper was replaced with a 60 g/m² paper, and the maximum temperature at which image was not generated at the rear end of the paper thus fed was designated as the highest fixing temperature at which hot offset does not occur. The difference between this highest fixing temperature and the above-described lowest fixing temperature was calculated as the fixable temperature range. The temperature range capable of fixing is considered sufficiently broad and improved; when the fixable temperature range is of 30° C. or more.

Evaluation of Heat-Resistant Storability

The change in the degree of aggregation at the time of leaving the toner particles to stand for 100 hours in an environment at a temperature of 50° C./a humidity of 80 RH % was measured. For the degree of aggregation, a POWDER TESTER (manufactured by HOSOKAWA MICRON CORPORATION; sieves 53, 45, and 38 μm) was used. When the sieves were mounted to be overlapped in the order of 53 μm, 45 μm, and 38 μm from the top, 2 g of the toner particles were loaded on the sieve at the top; and the sieves were vibrated, the mass of toner particles remaining on each of the sieves was measured (amplitude 1 mm, vibration time for 40 seconds), and the degree of aggregation was calculated according to the following formula:

Degree of aggregation=(T/2+C/2×(3/5)+B/2×(1/5))/100

wherein T represents a mass of toner particles remaining on the sieve in the upper row, C represents a mass of toner particles remaining on the sieve in the middle row, and B represents a mass of toner particles remaining on the sieve in the lower row.

The ratio of the degree of aggregation after leaving for 100 hours with respect to the initial degree of aggregation before leaving for 100 hours in the above-described environment (after leaving/before leaving) was designated as the ratio of the degree of aggregation. The heat-resistant storability may be considered suitable or sufficiently improved, when the ratio of the degree of aggregation is 5 or lower.

The results of the evaluations carried out are indicated in Table 2A for the toner particles of Examples 1 to 6, and in Table 2B for the toner particles of Comparative Examples 1 to 3.

TABLE 2A

| | | Examples | | | | | |
|---|---|---|---|---|---|---|---|
| | | 1 | 2 | 3 | 4 | 5 | 6 |
| Configuration | Type of first amorphous | 1A | 1B | 1A | 1A | 1A | 1A |
| of toner | polyester resin | | | | | | |
| particles | Content of crystalline polyester | 20 | 20 | 25 | 25 | 20 | 20 |
| | resin (% by mass) | | | | | | |
| | Type of thermally expandable | A | A | A | B | A | A |
| | capsule | | | | | | |
| | Content of thermally expandable | 2.8 | 2.8 | 2.8 | 2.8 | 0.9 | 4.6 |
| | capsule (% by mass) | | | | | | |
| Physical | T1 (° C.) | 83 | 91 | 76 | 76 | 83 | 83 |
| properties of | T2 (° C.) | 137 | 141 | 123 | 123 | 137 | 137 |
| toner | T0 − T1 (° C.) | 32 | 24 | 39 | 4 | 32 | 32 |
| particles | T2 − T0 (° C.) | 22 | 26 | 8 | 43 | 22 | 22 |
| Evaluation | Lowest fixing temperature (° C.) | 123 | 133 | 117 | 120 | 123 | 127 |
| results | Fixable temperature (° C.) | 42 | 37 | 33 | 35 | 37 | 38 |
| | Ratio of degree of aggregation | 1.49 | 1.14 | 2.24 | 1.13 | 0.84 | 1.11 |

TABLE 2B

| | | Comparative Examples | | |
|---|---|---|---|---|
| | | 1 | 2 | 3 |
| Configuration | Type of first amorphous | 1A | Comparative | 1A |
| of toner | polyester resin | | 1a | |
| particles | Content of crystalline polyester | 20 | 20 | — |
| | resin (% by mass) | | | |
| | Type of thermally expandable | — | A | A |
| | capsule | | | |
| | Content of thermally expandable | — | 2.8 | 2.8 |
| | capsule (% by mass) | | | |
| Physical | T1 (° C.) | 83 | 105 | 111 |
| properties of | T2 (° C.) | 137 | 144 | 154 |
| toner | T0 − T1 (° C.) | — | 10 | 4 |
| particles | T2 − T0 (° C.) | — | 29 | 39 |
| Evaluation | Lowest fixing temperature (° C.) | 123 | 152 | 165 |
| results | Fixable temperature (° C.) | 27 | 18 | 15 |
| | Ratio of degree of aggregation | 1.48 | 1.27 | 1.26 |

Examples of the toner particles described above are improved in terms of the low-temperature fixability (for example, the lowest fixing temperature is 135° C. or lower), the fixable temperature range (for example, the fixable temperature range is 30° C. or greater), and the heat-resistant storability (for example, the ratio of the degree of aggregation is 5 or lower).

It is to be understood that not all aspects, advantages and features described herein may necessarily be achieved by, or included in, any one particular example. Indeed, having described and illustrated various examples herein, it should be apparent that other examples may be modified in arrangement and detail.

1. A toner particle comprising:
a binder resin comprising an amorphous polyester resin having a pendant group, and a crystalline polyester resin;
a thermally expandable capsule;
a colorant; and
a wax.

2. The toner particle according to claim 1, wherein the amorphous polyester resin comprises, as monomer units, a polyhydric alcohol, a first polycarboxylic acid having a branch chain having 3 or more carbon atoms, the first polycarboxylic acid constituting the pendant group, and a second polycarboxylic acid having no branch chain having 3 or more carbon atoms.

3. The toner particle according to claim 2, wherein a content of the first polycarboxylic acid is of approximately 1% by mole to 20% by mole based on a total amount of the monomer units.

4. The toner particle according to claim 1, wherein a weight average molecular weight of the amorphous polyester resin is of approximately 5,000 to 40,000.

5. The toner particle according to claim 1, wherein a weight average molecular weight of the crystalline polyester resin is of approximately 5,000 to 15,000.

6. The toner particle according to claim 1, wherein the thermally expandable capsule encloses a hydrocarbon having a boiling point of approximately 50° C. or less.

7. The toner particle according to claim 1, wherein an expansion initiation temperature of the thermally expandable capsule is higher than the temperature at which a storage modulus of the binder resin is 1×10⁵ Pa.

8. The toner particle according to claim 1, wherein an expansion initiation temperature of the thermally expandable capsule is higher by 3° C. to 43° C., relative to the temperature at which a storage modulus of the toner particle is 1×10′ Pa.

9. The toner particle according to claim 1, wherein an expansion initiation temperature of the thermally expandable capsule is lower than the temperature at which a storage modulus of the binder resin is 5×10³ Pa.

10. The toner particle according to claim 1, wherein an expansion initiation temperature of the thermally expandable capsule is lower by 5° C. to 50° C., relative to the temperature at which a storage modulus of the binder resin is 5×10³ Pa.

11. The toner particle according to claim 1, wherein a content of the amorphous polyester resin is of approximately 70% by mass to 90% by mass based on a total amount of the binder resin.

12. The toner particle according to claim 1, wherein a content of the crystalline polyester resin is of approximately 8% by mass to 30% by mass based on a total amount of the binder resin.

13. The toner particle according to claim 1, wherein a content of the binder resin is of approximately 40% by mass to 90% by mass based on a total amount of the toner particle.

14. The toner particle according to claim 1, wherein a content of the thermally expandable capsule is of approximately 0.5% by mass to 5% by mass based on a total amount of the toner particle.

15. A toner cartridge comprising:
a container having an accommodation space; and
toner particles located in the accommodation space of the container, wherein each of the toner particles comprises:
a binder resin comprising an amorphous polyester resin having
a pendant group, and a crystalline polyester resin;
a thermally expandable capsule;
a colorant; and
a wax.
